(19) United States
(12) Patent Application Publication
(10) Pub. No.: US 2010/0113691 A1
(43) Pub. Date: May 6, 2010

(54) FLUORO OLEFIN POLYMERIZATION

(75) Inventors: Sheng Peng, Hockessin, DE (US); Ming-Hong Hung, Wilmington, DE (US); Christopher P. Junk, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/265,942

(22) Filed: Nov. 6, 2008

(51) Int. Cl. C08L 67/00

(52) U.S. Cl. 524/845; 524/878; 524/857

(57) ABSTRACT

A process comprising polymerizing at least one fluorinated monomer in an aqueous medium containing initiator and polymerization agent to form an aqueous dispersion of particles of fluoropolymer, wherein said polymerization agent is a compound of the formula (I):

R^{f}—O—(CF₂)ₙ—COOX (I)

wherein
R_{f} is CF₃CF₂CF₂—,
n is an integer equal to 3, 5 or 7, and
X is H, NH₄, Li, Na or K.

### FIELD OF THE INVENTION

This invention relates to a process for the dispersion polymerization of at least one fluorinated monomer in an aqueous polymerization medium.

### BACKGROUND OF THE INVENTION

Successful production of a high solids fluoropolymer dispersion generally requires the presence of a fluorosurfactant in order to stabilize the dispersion and prevent coagulation of the fluoropolymer particles being formed. Fluorosurfactants used in dispersion polymerization of fluorinated monomers are generally anionic, non-telogenic, soluble in water and stable to reaction conditions. The most widely used fluorosurfactants are perfluoroalkane carboxylic acids and salts, in particular perfluorooctanoic acid and salts and perfluorononanoic acid and salts. It is known that the presence of a fluorocarbon “tail” in the hydrophobic segment of surfactants provides extremely low surface energy. Such fluorinated surfactants are much more surface active than their hydrocarbon counterparts. In U.S. Pat. No. 3,706,773, Anello et al. disclosed fluorocarbon carboxylic acids which have a highly fluorinated terminal branched-chain linked through an ether oxygen. However, such fluorinated surfactants containing a branched-chain fluorinated ether have disadvantages. One such disadvantage is that perfluoroketone, particularly hexafluoroacetone, which is a severe skin irritant and highly toxic compound, is used in the preparation of such branched-chain fluorinated ethers.

Partially fluorinated ether carboxylic acids and salts, and perfluorinated ethyl or butyl ethers have been used in dispersion polymerizations as disclosed in US Patent Application 2007/0276103. In addition US Patent Application 2007/0015864 discloses fluorinated and partially fluorinated ether carboxylic acids and salts used in dispersion polymerization. Partially fluorinated surfactants are not as surface active as perfluorinated surfactants. In general, the existence of protons in partially fluorinated surfactants will induce the chain transfer phenomena and hence results in less efficient and inferior performance as the surfactant for fluoroolefin polymerization.

The cost of a fluorinated surfactant is determined primarily by the amount of fluorine incorporated into the compound. Thus more fluorine means a higher price. However, the performance of the fluorinated surfactants, for example, in surface tension reduction, is proportional to the fluorinated carbon chain length of the fluorinated surfactants. Increasing the fluorinated carbon chain length increases the efficiency of surface tension reduction, but increases the expense.

There is a need for a process for the dispersion polymerization of fluorinated monomers to form an aqueous dispersion of particles of fluoropolymer which is stable over various conditions. There is a need to minimize the amount of fluorine in the fluorosurfactant used in such polymerizations without adversely affecting the stability of the resulting dispersion. The present invention provides such a process for the dispersion polymerization of a fluorinated monomer to form stable aqueous dispersions of fluoropolymers.

### BRIEF SUMMARY OF THE INVENTION

The present invention comprises a process comprising polymerizing at least one fluorinated monomer in an aqueous medium containing initiator and polymerization agent to form an aqueous dispersion of particles of fluoropolymer, wherein said polymerization agent is a compound of the formula (I):

R_{f}—O—(CF₂)ₙ—COOX (I)

wherein
R_{f} is CF₃CF₂CF₂—,
n is an integer equal to 3, 5 or 7, and
X is H, NH₄, Li, Na or K.

### DETAILED DESCRIPTION OF THE INVENTION

Trademarks are shown herein by capitalization.

### Fluoropolymer

Fluoropolymer dispersions formed by this invention are comprised of particles of fluoropolymer made from at least one fluorinated monomer, i.e., wherein at least one of the monomers contains fluorine, preferably an olefinic monomer with at least one fluorine or a perfluoroalkyl group attached to a doubly-bonded carbon. The fluorinated monomer used in the process of this invention is preferably independently selected from the group consisting of tetrafluoroethylene (TFE), hexafluoropropylene (HFP), chlorotrifluoroethylene (CTFE), trifluoroethylene, hexafluoroisobutylene, perfluoroalkyl ethylene, fluorovinyl ethers, vinyl fluoride (VF), vinylidene fluoride (VF2), perfluoro-2,2-dimethyl-1,3-dioxole (PDD), perfluoro-2-methylene-4-methyl-1,3-dioxolane (PMD), perfluoro(allyl vinyl ether) and perfluoro(butenyl vinyl ether). A preferred perfluoroalkyl ethylene monomer is perfluorobutyl ethylene (PFBE). Preferred fluorovinyl ethers include perfluoro(alkyl vinyl ether) monomers (PAVE) such as perfluoro(propyl vinyl ether) (PPVE), perfluoro(ethyl vinyl ether) (PEVE), and perfluoro(methyl vinyl ether) (PMVE). Non-fluorinated olefinic comonomers such as ethylene and propylene can be copolymerized with fluorinated monomers.

Fluorovinyl ethers also include those useful for introducing functionality into fluoropolymers. These include CF₂═CF—(O—CF₂CFR_{f})ₐ—O—CF₂CFR′_{f}SO₂F, wherein R_{f} and R′_{f} are independently selected from F, Cl or a perfluorinated alkyl group having 1 to 10 carbon atoms, a=0, 1 or 2. Polymers of this type are disclosed in U.S. Pat. No. 3,282,875 (CF₂═CF—O—CF₂CF(CF₃)—O—CF₂CF₂SO₂F, perfluoro(3,6-dioxa-4-methyl-7-octenesulfonyl fluoride)), and in U.S. Pat. Nos. 4,358,545 and 4,940,525 (CF₂═CF—O—CF₂CF₂SO₂F). Another example is CF₂═CF—O—CF₂—CF(CF₃)—O—CF₂CF₂CO₂CH₃, methyl ester of perfluoro(4,7-dioxa-5-methyl-8-nonenecarboxylic acid), disclosed in U.S. Pat. No. 4,552,631. Similar fluorovinyl ethers with functionality of nitrile, cyanate, carbamate, and phosphate are disclosed in U.S. Pat. Nos. 5,637,748; 6,300,445; and 6,177,196.

The invention is especially useful when producing dispersions of polytetrafluoroethylene (PTFE) including modified polytetrafluoroethylene (modified PTFE). PTFE and modified PTFE typically have a melt creep viscosity of at least about 1×10⁸ Pa·s and, with such high melt viscosity, the polymer does not flow significantly in the molten state and therefore is not a melt-processible polymer.

Polytetrafluoroethylene (PTFE) refers to the polymerized tetrafluoroethylene by itself without any significant comonomer present. Modified PTFE refers to copolymers of tetrafluoroethylene (TFE) with such small concentrations of comonomer that the melting point of the resultant polymer is not substantially reduced below that of PTFE. The concentration of such comonomer is preferably less than 1% by weight, more preferably less than 0.5% by weight. A minimum amount of at least about 0.05% by weight is preferably used to have significant effect. The modified PTFE contains a small amount of comonomer modifier which improves film forming capability during baking (fusing), such as perfluoroolefin, notably hexafluoropropylene (HFP) or perfluoro(alkyl vinyl ether) (PAVE), where the alkyl group contains 1 to 5 carbon atoms, with perfluoro(ethyl vinyl ether) (PEVE) and perfluoro(propyl vinyl ether) (PPVE) being preferred. Chlorotrifluoroethylene (CTFE), perfluorobutyl ethylene (PFBE), or other monomer that introduces bulky side groups into the molecule are also included.

The invention is especially useful when producing dispersions of melt-processible fluoropolymers. By melt-processible, it is meant that the polymer can be processed in the molten state (i.e., fabricated from the melt into shaped articles such as films, fibers, and tubes etc. that exhibit sufficient strength and toughness to be useful for their intended purpose) using conventional processing equipment such as extruders and injection molding machines. Examples of such melt-processible fluoropolymers include homopolymers such as polychlorotrifluoroethylene or copolymers of tetrafluoroethylene (TFE) and at least one fluorinated copolymerizable monomer (comonomer) present in the polymer usually in sufficient amount to reduce the melting point of the copolymer substantially below that of tetrafluoroethylene (TFE) homopolymer, polytetrafluoroethylene (PTFE), e.g., to a melting temperature no greater than 315° C.

A melt-processible tetrafluoroethylene (TFE) copolymer typically incorporates an amount of comonomer into the copolymer in order to provide a copolymer which has a melt flow rate (MFR) of about 1-100 g/10 min as measured according to ASTM D-1238 at the temperature which is standard for the specific copolymer. Preferably, the melt viscosity is at least about 10² Pa·s, more preferably, will range from about 10² Pa·s to about 10⁶ Pass, most preferably about 10³ to about 10⁵ Pa·s measured at 372° C. by the method of ASTM D-1238 modified as described in U.S. Pat. No. 4,380,618. Additional melt-processible fluoropolymers are the copolymers of ethylene (E) or propylene (P) with tetrafluoroethylene (TFE) or chlorotrifluoroethylene (CTFE), notably ethylene tetrafluoroethylene (ETFE), ethylene chlorotrifluoroethylene (ECTFE) and propylene chlorotrifluoroethylene (PCTFE). A preferred melt-processible copolymer for use in the practice of the present invention comprises at least about 40-98 mol % tetrafluoroethylene units and about 2-60 mol % of at least one other monomer. Preferred comonomers with tetrafluoroethylene (TFE) are perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, and the copolymer can be made using several PAVE monomers.

Preferred tetrafluoroethylene (TFE) copolymers include 1) tetrafluoroethylene/hexafluoropropylene (TFE/HFP) copolymer; 2) tetrafluoroethylene/perfluoro(alkyl vinyl ether) (TFE/PAVE) copolymer; 3) tetrafluoroethylene/hexafluoro propylene/perfluoro (alkyl vinyl ether) (TFE/HFP/PAVE) copolymer wherein the perfluoro (alkyl vinyl ether) is perfluoro(ethyl vinyl ether) or perfluoro(propyl vinyl ether); 4) melt processible tetrafluoroethylene/perfluoro(methyl vinyl ether)/perfluoro (alkyl vinyl ether) (TFE/PMVE/PAVE) copolymer wherein the alkyl group of perfluoro (alkyl vinyl ether) (PAVE) has at least two carbon atoms); and 5) tetrafluoroethylene/hexafluoropropylene/vinylidene fluoride copolymer (TFE/HFP/VF2)).

Further useful polymers are film forming polymers of polyvinylidene fluoride (PVDF) and copolymers of vinylidene fluoride as well as polyvinyl fluoride (PVF) and copolymers of vinyl fluoride.

The invention is also useful when producing dispersions of fluorocarbon elastomers. These elastomers typically have a glass transition temperature below 25° C. and exhibit little or no crystallinity at room temperature. Fluorocarbon elastomer copolymers made by the process of this invention typically contain 25 to 70% by weight, based on total weight of the fluorocarbon elastomer, of copolymerized units of a first fluorinated monomer which may be vinylidene fluoride (VF2) or tetrafluoroethylene (tetrafluoroethylene (TFE)). The remaining units in the fluorocarbon elastomers are comprised of one or more additional copolymerized monomers, different from said first monomer, selected from the group consisting of fluorinated monomers, hydrocarbon olefins and mixtures thereof. Fluorocarbon elastomers prepared by the process of the present invention may also, optionally, comprise units of one or more cure site monomers. When present, copolymerized cure site monomers are typically at a level of 0.05 to 7% by weight, based on total weight of fluorocarbon elastomer. Examples of suitable cure site monomers include: i) bromine-, iodine-, or chlorine—containing fluorinated olefins or fluorinated vinyl ethers; ii) nitrile group-containing fluorinated olefins or fluorinated vinyl ethers; iii) perfluoro(2-phenoxypropyl vinyl ether); and iv) non-conjugated dienes.

Preferred tetrafluoroethylene (TFE) based fluorocarbon elastomer copolymers include tetrafluoroethylene/perfluoro(methyl vinyl ether) (TFE/PMVE); tetrafluoroethylene/perfluoro(methyl vinyl ether)/ethylene (TFE/PMVE/E); tetrafluoroethylene/propylene (TFE/P); and tetrafluoroethylene/propylene/vinylidene fluoride (TFE/P/VF2). Preferred vinylidene fluoride (VF2) based fluorocarbon elastomer copolymers include vinylidene fluoride/hexafluoropropylene (VF2/HFP); vinylidene fluoride/hexafluoropropylene/tetrafluoroethylene (VF2/HFP/TFE); and vinylidene fluoride/perfluoro(methyl vinyl ether)/tetrafluoroethylene (VF2/PMVE/TFE). Any of these elastomer copolymers may further comprise units of cure site monomer.

### Surfactant Polymerization Agent

A process in accordance with the invention comprises polymerizing at least one fluorinated monomer in an aqueous medium containing initiator and polymerization agent to form an aqueous dispersion of particles of fluoropolymer, said fluoropolymer as described above. The polymerization agent is a perfluoroalkyl ether acid or salt surfactant containing one oxygen, represented by the following formula (I):

R_{f}—OP—(CF₂)ₙ—COOX (1)

### Wherein

R_{f} is CF₃CF₂CF₂—,
n is an integer equal to 3, 5 or 7, and
X is H, NH₄, Li, Na or K.

Preferably n is 3 or 5, and more preferably n is 3. Preferably X is Na, H, or NH₄, more preferably X is NH₄.

“Chain length” as used in this application refers to the number of atoms in the longest linear chain in the hydrophobic tail of the perfluoroalkyl ether surfactant employed in the process of this invention. Chain length includes atoms such as oxygen atoms in addition to carbon in the chain of hydrophobic tail of the perfluoroalkyl ether surfactant but does not include branches off of the longest linear chain or include atoms of the anionic group, e.g., does not include the carbon in carboxylate.

One of the advantages of using the surfactants comprising the perfluoroalkyl ether surfactant of formula (I) in a dispersion polymerization process is the achievement of a more stable dispersion. Preferably an increased polymerization rate using reduced concentration of fluorinated surfactant having a reduced fluorine content to increase the “fluorine efficiency” is also achieved. By the term “fluorine efficiency” as used herein is meant the ability to use a minimum amount of fluorosurfactants and use a lower level of fluorine to obtain the desired dispersion of polymers. The level of fluorine content is expressed as micrograms of fluorine in surfactant per gram of polymer. Use of perfluoropolyethers having branched end groups usually requires higher fluorosurfactant concentration than with the perfluoropolyethers having linear end groups.

The efficiency of fluorinated surfactants, for example, in surface tension reduction, is proportional to the fluorinated carbon chain length present. Increasing the fluorinated carbon chain length increases the efficiency of surface tension reduction. The perfluoroalkyl ether surfactant of formula (I) used in the present invention increases the “fluorine efficiency” because a minimum amount of the perfluoroalkyl ether surfactant can be used to obtain the desired surfactant effects in the aqueous dispersion polymerization of olefin fluoromonomers.

In accordance with the invention, the perfluoroalkyl ether acid or salt of formula (I) is preferably dispersed adequately in aqueous medium to function effectively as a polymerization agent. “Dispersed” as used in this application refers to either dissolved in cases in which the perfluoroalkyl ether acid or salt surfactant is soluble in the aqueous medium, or dispersed in cases in which the perfluoroalkyl ether acid or salt surfactant is not fully soluble and is present in very small particles, for example about 1 nm to about 1 micrometer particle size distribution, in the aqueous medium Similarly, “dispersing” as used in this application refers to either dissolving or dispersing the perfluoroalkyl ether acid or salt surfactant so that it is dispersed as defined above. Preferably, the perfluoroalkyl ether acid or salt surfactant is dispersed sufficiently so that the polymerization medium containing the perfluoroalkyl ether acid or salt surfactant appears water clear or nearly water clear.

Preferably, the total amount of polymerization agent used in a preferred process in accordance with the invention is from about 5 to about 10,000 micrograms/g based on the weight of water in the aqueous medium, more preferably from about 5 to about 3000 micrograms/g based on the weight of water in the aqueous medium. Even more preferably, the total amount of polymerization agent used is from about 0.01% by weight to about 10% by weight based on the weight of water in the aqueous medium, still more preferably from about 0.05% to about 3% by weight, more preferably from about 0.05% to about 3% based on the weight of water in the aqueous medium.

At least a portion of the polymerization agent is preferably added to the polymerization prior to the beginning of the polymerization. If added subsequently, a variety of modes of addition for the polymerization agent can be used including continuously throughout the polymerization, or in doses or intervals at predetermined times during the polymerization. In accordance with one embodiment of the invention, substantially all of the polymerization agent is added to the aqueous medium prior to the start of polymerization, preferably prior to initiator addition.

In accordance with a preferred embodiment of the invention the polymerization agent used in the practice of this invention is preferably substantially free of perfluoropolyether oil (i.e., perfluoropolyethers having neutral, nonionic, preferably fluorine or hydrogen, end groups). Substantially free of perfluoropolyether oils means that aqueous polymerization medium contains no more than about 10 micrograms/g of such oils based on water. Thus, the fluoropolymer dispersion preferably produced has high purity and contains low residual surfactant and preferably is substantially free of perfluoropolyether oils.

Moreover, in a preferred process, the polymerization medium is substantially free of fluoropolymer seed at the start of polymerization (kick-off). In this preferred form of the invention, fluoropolymer seed, i.e., separately polymerized small fluoropolymer particles in dispersion form, is not added prior to the start of polymerization.

It has been found that the polymerization agent of formula (I) used in the present invention can produce fluoropolymers and provide reduced undispersed polymer (referred to as coagulum) substantially equivalent to those made using the typical perfluoroalkane carboxylic acid surfactants and at high dispersion solids concentrations.

The present invention further comprises the manufacture of the fluorinated acids and salts of formula (I) containing one oxygen. Such compounds of formula (I) are prepared according to the following scheme:

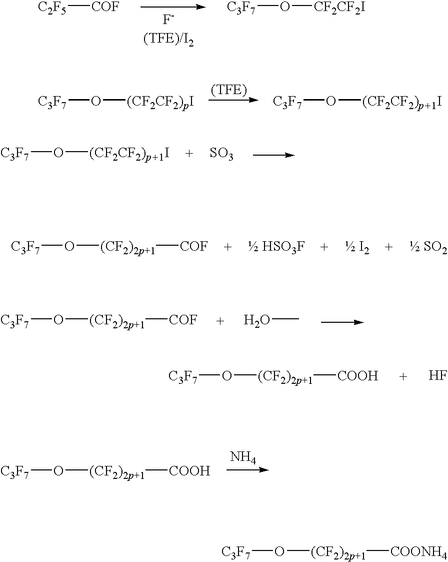

The perfluoroalkyl ether iodide C₃F₇—O—CF₂CF₂I having a linear end group C₃F₇ is prepared by contacting C₂F₅—COF with tetrafluoroethylene (TFE), iodine (I₂), and HF or alkali metal fluoride (F⁻). Alternatively, the perfluoroalkyl ether iodide C₃F₇—O—CF₂CF₂I also can be prepared by the procedure described in U.S. Pat. No. 5,481,028, herein incorporated by reference, in Example 8, which discloses the preparation of this compound from perfluoro-n-propyl vinyl ether. The telomerization of tetrafluoroethylene (tetrafluoroethylene (TFE)) with the linear perfluoroether iodides C₃F₇—O—CF₂CF₂I prepared as above produces the compounds of the structure C₃F₇—O—(CF₂CF₂)ₚ₊₁I, wherein, p is an integer of 1 to 3 or more, preferably 1 to 3. These compounds are contacted with SO₃ to produce the compounds of the fluorinated acids containing one oxygen having the structure C₃F₇—O—(CF₂)₂ₚ₊₁—COF which when hydrolyzed yield C₃F₇—O—(CF₂)₂ₚ₊₁—COOH, which then can be converted to the related salts, such as the compounds of the structure C₃F₇—O—(CF₂)₂ₚ₊₁—COONH₄.

### Polymerization Process

The process can also be carried out as a batch, semi-batch or continuous process in a pressurized reactor. In a batch process, all of the ingredients are added to the polymerization reactor at the beginning of the run and are allowed to react to completion before discharging the vessel. In a semibatch process, one or more ingredients (such as monomers, initiator, surfactant, etc.) are added to the vessel over the course of the reaction following the initial precharging of the reactor. At the completion of a semibatch process, the contents are discharged from the vessel. In a continuous process, the reactor is precharged with a predetermined composition and then monomers, surfactants, initiators and water are continuously fed into the reactor while an equivalent volume of reaction goods are continuously removed from the reactor, resulting in a controlled volume of reacting goods inside the reactor. Following this start-up procedure, a continuous process can run indefinitely as long as feed material continues to be metered into the reactor and product goods are removed. When shut-down is desired, the feeds to the reactor can be stopped and the reactor discharged.

In one preferred embodiment of the invention, the polymerization process is carried out as a batch process in a pressurized reactor. Suitable vertical or horizontal reactors for carrying out the process of the invention are equipped with stirrers for the aqueous medium. The reactor provides sufficient contact of gas phase monomers such as tetrafluoroethylene (TFE) for desirable reaction rates and uniform incorporation of comonomers if employed. The reactor preferably includes a cooling jacket surrounding the reactor so that the reaction temperature is conveniently controlled by circulation of a controlled temperature heat exchange medium.

In a typical process, the reactor is first charged with deionized and deaerated water of the polymerization medium, and the perfluoroalkyl ether acid or salt surfactant of formula (I) is dispersed in the medium. The dispersing of the perfluoroalkyl ether acid or salt surfactant is as discussed above. At least a portion of the polymerization agent is preferably added to the polymerization prior to the beginning of the polymerization. If added subsequently, a variety of modes of addition for the polymerization agent can be used including continuously throughout the polymerization, or in doses or intervals at predetermined times during the polymerization.

For polytetrafluoroethylene (PTFE) homopolymer and modified polytetrafluoroethylene (PTFE), paraffin wax as stabilizer is often added. A suitable procedure for polytetrafluoroethylene (PTFE) homopolymer and modified polytetrafluoroethylene (PTFE) includes first pressurizing the reactor with tetrafluoroethylene (TFE). If used, the comonomer such as hexafluoropropylene (HFP) or perfluoro(alkyl vinyl ether) (PAVE) is then added.

A free-radical initiator solution such as ammonium persulfate solution is then added. For polytetrafluoroethylene (PTFE) homopolymer and modified polytetrafluoroethylene (PTFE), a second initiator which is a source of succinic acid such as disuccinyl peroxide may be present in the initiator solution to reduce coagulum. Alternatively, a redox initiator system such as potassium permanganate/oxalic acid is used. The temperature is increased and, once polymerization begins, additional tetrafluoroethylene (TFE) is added to maintain the pressure. The beginning of polymerization is referred to as kick-off and is defined as the point at which gaseous monomer feed pressure is observed to drop substantially, for example, about 10 psi (about 70 kPa). Comonomer and/or chain transfer agent can also be added as the polymerization proceeds. For some polymerizations, additional monomers, initiator and or polymerization agent may be added during the polymerization.

After batch completion (typically several hours) when the desired amount of polymer or solids content has been achieved, the feeds are stopped, the reactor is vented and purged with nitrogen, and the raw dispersion in the vessel is transferred to a cooling vessel.

The solids content of the dispersion upon completion of polymerization can be varied depending upon the intended use for the dispersion. For example, the process of the invention can be employed to produce a “seed” dispersion with low solids content, e.g., less than 10% by weight, which is employed as “seed” for a subsequent polymerization process to a higher solids level. In other processes, the solids content of fluoropolymer dispersion produced by the process of the invention is preferably at least about 10% by weight. More preferably, the fluoropolymer solids content is at least about 20% by weight. A preferred range for fluoropolymer solids content produced by the process is about 14% by weight to about 65% by weight, even more preferably about 20% by weight to about 55% by weight, most preferably, about 35% by weight to about 55% by weight.

In a preferred process of the invention, polymerizing produces less that about 10% by weight, more preferably less than 3% by weight, even more preferably less than 1% by weight, most preferably less that about 0.5% by weight undispersed fluoropolymer (coagulum) based on the total weight of fluoropolymer produced.

The as-polymerized dispersion can be stabilized with anionic, cationic, or nonionic surfactant for certain uses. Typically however, the as-polymerized dispersion is transferred to a dispersion concentration operation which produces concentrated dispersions stabilized typically with nonionic surfactants by known methods. Solids contents of concentrated dispersion are typically about 35 to about 70% by weight. Certain grades of polytetrafluoroethylene (PTFE) dispersion are made for the production of fine powder. For this use, the dispersion is coagulated, the aqueous medium is removed and the polytetrafluoroethylene (PTFE) is dried to produce fine powder.

The dispersion polymerization of melt-processible copolymers is similar except that comonomer in significant quantity is added to the batch initially and/or introduced during polymerization. Chain transfer agents are typically used in significant amounts to decrease molecular weight to increase melt flow rate. The same dispersion concentration operation can be used to produce stabilized concentrated dispersions. Alternatively, for melt-processible fluoropolymers used as molding resin, the dispersion is coagulated and the aqueous medium is removed. The fluoropolymer is dried, then processed into a convenient form such as flake, chip or pellet for use in subsequent melt-processing operations.

The process of the invention can also be carried out as a semi-batch or as a continuous process in a pressurized reactor. These processes are especially suitable for the manufacture of fluorocarbon elastomers. In the semi-batch emulsion polymerization process of this invention, a gaseous monomer mixture of a desired composition (initial monomer charge) is introduced into a reactor which contains an aqueous medium precharge. Other ingredients, such as initiators, chain transfer agents, buffers, bases, and surfactants can be added with the water in the precharge, and also during the polymerization reaction. Additional monomers at concentrations appropriate to the final polymer composition desired, are added during the polymerization reaction at a rate needed to maintain system pressure. Polymerization times in the range of from about 2 to about 30 hours are typically employed in the semi-batch polymerization process. In a continuous process, the reactor is completely filled with aqueous medium so that there is no vapor space. Gaseous monomers and solutions of other ingredients such as water-soluble monomers, chain transfer agents, buffer, bases, polymerization initiator, surfactant, etc., are fed to the reactor in separate streams at a constant rate. Feed rates are controlled so that the average polymer residence time in the reactor is generally between 0.2 to about 4 hours, depending on monomer reactivity. For both types of processes, the polymerization temperature is maintained in the range of from about 25° to about 130° C., preferably in the range of from about 50° C. to about 100° C. for semi-batch operation, and from about 70° C. to about 120° C. for continuous. The polymerization pressure is controlled in the range of from about 0.5 to about 10 MPa, preferably from about 1 to about 6.2 MPa. The amount of fluoropolymer formed is approximately equal to the amount of incremental feed charged, and is in the range of from about 10 to about 30 parts by weight of fluoropolymer per 100 parts by weight of aqueous emulsion, preferably in the range of from about 20 to about 30 parts by weight of the fluoropolymer.

Polymerization in accordance with the invention employs free radical initiators capable of generating radicals under the conditions of polymerization. As is well known in the art, initiators for use in accordance with the invention are selected based on the type of fluoropolymer and the desired properties to be obtained, e.g., end group type, molecular weight, etc. For some fluoropolymers such as melt-processible tetrafluoroethylene (TFE) copolymers, water-soluble salts of inorganic peracids are employed which produce anionic end groups in the polymer. Preferred initiators of this type have a relatively long half-life, preferably persulfate salts, e.g., ammonium persulfate or potassium persulfate. To shorten the half-life of persulfate initiators, reducing agents such as ammonium bisulfite or sodium metabisulfite, with or without metal catalyst salts such as Fe, can be used. Preferred persulfate initiators are substantially free of metal ions and most preferably are ammonium salts.

For the production of polytetrafluoroethylene (PTFE) or modified polytetrafluoroethylene (PTFE) dispersions for dispersion end uses, small amounts of short chain dicarboxylic acids such as succinic acid or initiators that produce succinic acid such as disuccinic acid peroxide (DSP) are preferably also added in addition to the relatively long half-life initiators such as persulfate salts.

Such short chain dicarboxylic acids are typically beneficial in reducing undispersed polymer (coagulum). For the production of polytetrafluoroethylene (PTFE) dispersion for the manufacture of fine powder, a redox initiator system such as potassium permanganate/oxalic acid is often used.

The initiator is added to the aqueous polymerization medium in an amount sufficient to initiate and maintain the polymerization reaction at a desired reaction rate. At least a portion of the initiator is preferably added at the beginning of the polymerization. A variety of modes of addition may be used including continuously throughout the polymerization, or in doses or intervals at predetermined times during the polymerization. A particularly preferred mode of operation is for initiator to be precharged to the reactor and additional initiator to be continuously fed into the reactor as the polymerization proceeds. Preferably, total amounts of ammonium persulfate and/or potassium persulfate employed during the course of polymerization are about 25 micrograms/g to about 250 micrograms/g based on the weight of the aqueous medium. Other types of initiators, for example, potassium permanganate/oxalic acid initiators, can be employed in amounts and in accordance with procedures as known in the art.

Chain-transfer agents can be used in a process in accordance with the invention for the polymerization of some types of polymers, e.g., for melt-processible tetrafluoroethylene (TFE) copolymers, to decrease molecular weight for the purposes of controlling melt viscosity. Chain transfer agents useful for this purpose are well-known for use in the polymerization of fluorinated monomers. Preferred chain transfer agents include hydrogen, aliphatic hydrocarbons, halocarbons, hydrohalocarbons or alcohols having 1 to 20 carbon atoms, more preferably 1 to 8 carbon atoms. Representative examples of such chain transfer agents are alkanes such as ethane, chloroform, 1,4-diiodoperfluorobutane and methanol.

The amount of a chain transfer agent and the mode of addition depend on the activity of the particular chain transfer agent and on the desired molecular weight of the polymer product. A variety of modes of addition can be used including a single addition before the start of polymerization, continuously throughout the polymerization, or in doses or intervals at predetermined times during the polymerization. The amount of chain train transfer agent supplied to the polymerization reactor is preferably about 0.005 to about 5% by weight, more preferably from about 0.01 to about 2% by weight based upon the weight of the resulting fluoropolymer.

In accordance with the invention, the present invention further provides a process as one of the embodiments of the invention comprising polymerizing olefin fluoromonomers in aqueous medium containing the perfluoroalkyl ether surfactants of formula (I). The perfluoroalkyl ether surfactants of formula (I) are used in the process of the aqueous dispersion polymerization of olefin fluoromonomers. Water-soluble initiator is generally used in amount of from about 2 to about 500 micrograms/g based on the weight of water present. Examples of such initiators include ammonium persulfate, potassium persulfate, permanganate/oxalic acid, and disuccinic acid peroxide. The polymerization can be carried out by charging the polymerization reactor with water, surfactant, olefin fluoromonomers, and optionally chain transfer agent, agitating the contents of the reactor, and heat the reactor to the desired polymerization temperature, e.g., from about 25° to about 110° C.

The amount of the perfluoroalkyl ether acid or salt surfactant of formula (I) used in the process of the invention mentioned above is within known ranges, for example, from about 0.01% by weight to about 10% by weight, preferably from about 0.05 to about 3% by weight, more preferably from about 0.05 to about 1.0% by weight, based on the water used in the polymerization. The concentration of surfactant that can be employed in the polymerization process of the present invention can be above or below the critical micelle concentration (c.m.c.) of the surfactant.

The present invention further provides a dispersion of fluoropolymers as the result of the aqueous dispersion polymerization of olefin fluoromonomers described above.

### Materials and Test Methods

The following materials and test methods were used in the examples herein.

### Test Method 1—Surface Tension Measurement

Surface tension was measured using a Kiruess Tensiometer, K11 Version 2.501 in accordance with instructions with the equipment. The Wilhelmy Plate method was used. A vertical plate of known perimeter was attached to a balance, and the force due to wetting was measured. Ten replicates were tested of each dilution, and the following machine settings were used: Method: Plate Method SFT; Interval: 1.0 s; Wetted length: 40.2 mm; Reading limit: 10; Min Standard Deviation: 2 dynes/cm; Gr. Acc.: 9.80665 m/s 2.

### Test Method 2—Comonomer Content

Comonomer content perfluoro(propyl vinyl ether) (PPVE) was measured by FTIR according to the method disclosed in U.S. Pat. No. 4,743,658, col. 5, lines 9-23 as follows. The PPVE content was determined by infrared spectroscopy. The ratio of absorbance at 10.07 micrometers to that at 4.25 micrometers was determined under a nitrogen atmosphere using films approximately 0.05 mm thick. The films were compression molded at 350° C., then immediately quenched in ice water. This absorbance ratio was then used to determine percent PPVE by means of a calibration curve established with reference films of known PPVE content. F19 NMR was used as the primary standard for calibrating the reference films.

### Test Method 3—Particle Size

Particle size, i.e., raw dispersion particle size (RDPS) was determined by laser fraction techniques that measure the particle size distributions (PSD) of materials using a Microtrac Ultrafine Particle Analyzer (UPA). The UPA uses dynamic light scattering principle for measuring PSD with size range of 0.003 micron to 6.54 micron. The samples were analyzed after collecting the background with water. The measurements were repeated three times and averaged.

### Test Method 4—Coagulation

Dry coagulum amount was measured by physically collecting the wet polymer that coagulated during the course of the polymerization, and drying the coagulum overnight at 80° C. at a vacuum of 30 mm Hg (4 kPa). The dried coagulum was weighed to determine the percentage present based on the weight of total fluoropolymer produced.

### Test Method 5—Glass Transition Temperature (Tg) and Melting Temperature(Tm)

The glass transition temperature (Tg) and melting temperature (Tm) were each determined by differential scanning calorimetry (DSC). DCS measurements were conducted using a Perkin Elmer Differential Scanning Calorimeter Pyris 1 instrument following instrument instructions. Scans were recorded at a heating rate of either 10° C. or 20° C. per minute at a temperature range of from −100° C. to 50° C. using nitrogen as the carrying gas. Values were reported after the second heating.

### Materials

Tetrafluoroethylene used was obtained from E.I. du Pont de Nemours and Company, Wilmington, Del. Olefins were commercial grade materials and were used as obtained. Other reagents including initiator, ammonium persulfate were commercially available, for example, from Aldrich Chemical Company, Milwaukee, Wis.

### Compound 1

Tetrafluoroethylene (180 g) was introduced to an autoclave charged with C₃F₇OCF₂CF₂I(600 g), and the reactor was heated at 230° C. for 2 hours. The same reaction was repeated twice. The products were combined and isolated by vacuum distillation to provide C₃F₇OCF₂CF₂CF₂CF₂I (370 g, 29%) based on the recovery of starting material. B.p. 63˜66° C. at 60 mm Hg (80×10² Pa); ¹⁹F NMR (300 MHz, CO(CD₃)₂: −65.63˜65.75 (2F, m), −82.65 (3F, t, J=7.3 Hz), −84.4184.54 (2F, m), −85.34˜85.47 (2F, m), −115.07 (2F, s), —125.49˜125.61 (2F, m), −131.03 (2F, s); MS: 513 (M+1).

A mixture of fuming oleum (65% SO₃ in H₂SO₄, 75 g), C₃F₇OCF₂CF₂CF₂CF₂T (50 g) and P₂O₅ (0.295 g) was heated at 105° C. for 12 hours. The resulting C₃F₇OCF₂CF₂CF₂COF was separated and hydrolyzed with 22% sulfuric acid (110 mL) overnight. After phase separation, the final acid C₃F₇OCF₂CF₂CF₂COOH (34 g, 91%) was obtained by vacuum distillation. B.p. 100˜103° C. at 40 mm Hg (53.3×10² Pa); ¹⁹F NMR (300 MHz, CO(CD₃)₂: −82.64 (3F, t, J=7.3 Hz), −84.26˜84.38 (2F, m), −85.34˜85.47 (2F, m), −120.56 (2F, t-d, J1=8.8 Hz, J2=2.0 Hz), −127.93 (2F, s), −131.03 (2F, s). NH₄HCO₃ (4.4 g) in 22 mL of water was added drop wise to C₃F₇OCF₂CF₂CF₂COOH (21 g) in 173 mL of water. The reaction was stirred for two hours at room temperature and the resulting salt C₃F₇OCF₂CF₂CF₂COONH₄ (20 g, 92%) was obtained as a white solid after evaporating the water. M.p. 125˜128° C.; ¹⁹F (300 MHz, CD₃COCD₃): −81.64 (3F, t, J=7.1 Hz), −83.87˜83.99 (2F, m), −84.60˜84.73 (2F, m), −118.23 (2F, t, J=7.3 Hz), −127.56 (2F, s), −130.16 (2F, s).

The surface tension of aqueous solution containing the product C₃F₇OCF₂CF₂CF₂COONH₄ produced above in Example 1 was measured according the procedure of Test Method 1. The results are shown in Table 1.

### Comparative Compound A

The procedure of Example 1 was employed, but using C₂F₅OCF₂CF₂1 as starting material, and the resulting compound C₂F₅OCF₂CF₂CF₂COONH₄ was obtained. Its surface tension was measured using Test Method 1. The results are shown in Table 1.

### Comparative Compound B

In a 1300 mL stainless steel shaker tube was charged perfluoro(propyl vinyl ether) (PPVE, 346 grams, 1.30 moles), iodine monochloride (248.5 grams, 1.53 moles), HF (500 grams, 25 moles), and boron trifluoride (50 grams, 0.737 moles). The tube was sealed and cool-evacuated. By “cool-evacuated” is meant that oxygen was removed from the reactor by cooling reactor contents sufficiently so that all ingredients remained in the reactor while a vacuum was applied to remove oxygen. The tube and contents were then heated at 75° C. for 24 hours while being shaken. After cooling, the product mixture was unloaded from the tube, and washed with saturated sodium bisulfite solution to remove unreacted residual iodine. After drying, the product (CF₃CF₂CF₂—O—CF₂CF₂—I) was distilled to a clear colorless liquid, bp. 85-86° C., yield: 400 grams (75%).

In a 1300 mL stainless steel shaker tube was charged 1-iodo-3-oxa-perfluorohexane (CF₃CF₂CF₂—O—CF₂CF₂—I) (370.8 grams, 0.90 moles) and d-(+)-Limonene (1.0 gram). The tube was sealed and cool-evacuated, and ethylene (42 grams, 1.50 moles) was transferred into the tube. The tube was sealed again and was heated at 220° C. for 10 hours. The product (CF₃CF₂CF₂—O—CF₂CF₂—CH₂CH₂—I) was unloaded from the tube and purified by distillation to give a pale-pink clear liquid, bp. 65-69° C. at 50 mm Hg (66.6×10² Pa). Yield: 340 grams (86%). ¹H-NMR (CDCl₃, 400 MHz): δ 3.24 (t, J=8.7 Hz, 2H), 2.72 (m, 2H); ¹⁹F-NMR (CDCl₃, 376.89 MHz): −81.8 (t, J=7.5 Hz, 3F), −84.5 (m, 2F), −88.0 (t, J=13.2 Hz, 2F), −119.3 (t, J=17 Hz, 2F), −130.4 (s, 2F).

In a reaction flask was charged a phase transfer catalyst ([C₁₂H₂₅][PhCH₂][CH₂CH(OH)CH₃]₂ available from DuPont) (60% aqueous solution) (29.6 grams, 0.042 moles), 10 M KOH solution (280 mL, 2.80 moles), along with 1-iodo-1,1,2,2-tetrahydro-5-oxa-perfluorooctane (CF₃CF₂CF₂—O—CF₂CF₂—CH₂CH₂—I) (176 grams, 0.40 moles). The reaction mixture was allowed to stir for 14 hours at ambient temperature. The product mixture was transferred into a separatory funnel and the bottom organic layer was separated, washed with water twice, dried over magnesium sulfate, then distilled to give CF₃CF₂CF₂—O—CF₂CF₂—CH═CH₂ product as a clear, colorless liquid, bp. 75-76° C., Yield: 172 grams (72%). ¹H-NMR (CDCl₃, 400 MHz): 65.90 (m, 1H), 5.92 (m, 2H); ¹⁹F-NMR (CDCl₃, 376.89 MHz): −81.9 (t, J=7.5 Hz, 3F), −85.1 (m, 2F), −85.3 (t, J=13.2 Hz, 2F), −118.3 (d, J=11.3 Hz, 2F), −130.5 (s, 2F).

KMnO₄ (50 g, 0.315 mol) was dissolved in deionized water, followed by addition of H₂SO₄ (53 g, 0.541 moles). C₃F₇OCF₂CF₂CH═CH₂ (prepared as in the examples above) (20 g, 0.094 moles) was added dropwise at 60° C. to the permanganate solution, and the oxidation reaction was run at 70° C. for 3 hours.

Then, the resulting solution was cooled to room temperature and thrice extracted with 100 mL ether. The extract was dried over MgSO₄ and then filtered. The fluorinated carboxylic acid product (C₃F₇OCF₂CF₂COOH) was distilled via vacuum distillation (9 g, 29% yield), b.p. 62-63° C. at 30 mm Hg (40×10² Pa).

¹⁹F NMR (376 MHz, CDCl₃): −84.52 (3F, t, J=8 Hz), −84.7˜−85.0 (2F, m), −86.17˜86.23 (2F, m), −125.20˜125.21 (2H, t, J=2.1 Hz), −134.49 (2F, s).

Ammonium bicarbonate solution (1.48 g, 0.0187 mol, in 10 mL water) was added to the fluorinated carboxylic acid C₃F₇OCF₂CF₂COOH (6 g, 0.0182 mol) produced above. The reaction was stirred at room temperature for an hour. Water was removed in a rotovap resulting in the product (C₃F₇OCF₂CF₂COONH₄) as a white solid (4 g, 79% yield), b.p. 121-123° C.

¹⁹F NMR (376 MHz, CDCl₃): −81.61 (3F, t, J=8 Hz), −84.76˜85.0 (2F, m), −86.17˜86.23 (2F, m), −121.17˜121.19 (2H, t, J=2.1 Hz), −130.27 (2F, s). It's surface tension was measured using Test Method 1. The results are shown in Table 1.

TABLE 1
Surface Tension Measurement (dyne/cm)

| Compound* | 0.001% | 0.005% | 0.010% | 0.050% | 0.100% | 0.200% | 0.500% | 1.00% |
|---|---|---|---|---|---|---|---|---|
| Compound 1 | 72.8 | 71.7 | 70.7 | 65.6 | 62.0 | 55.8 | 45.3 | 35.5 |
| (307) | | | | | | | | |
| Comparative | 72.8 | 72.8 | 72.4 | 69.7 | 67.7 | 63.9 | 55.7 | 44.9 |
| Compound A | | | | | | | | |
| (207) | | | | | | | | |
| Comparative | 72.8 | 71.7 | 72.4 | 69.5 | 67.1 | 63.2 | 55.4 | 44.9 |
| Compound B | | | | | | | | |
| (306) | | | | | | | | |

*Each compound was added to deionized water by weight based on solids of the additive in deionized water; Standard Deviation <1 dynes/cm; Temperature 23° C.
Normal surface tension of deionized water is 72 dyne/cm.

The data in Table 1 shows that when the above perfluoroalkyl ether surfactant was added to deionized water at a specified rate, the surface tension of each aqueous solution was reduced significantly. Compound 1 showed better surface tension reduction than either Comparative Compounds A and B as the concentration increased.

### Compound 2

Tetrafluoroethylene (180 g) was introduced to an autoclave charged with C₃F₇OCF₂CF₂I (600 g), and the reactor was heated at 230° C. for 2 h. The same reaction was repeated twice. The products were combined and isolated by vacuum distillation to provide C₃F₇OCF₂CF₂CF₂CF₂CF₂CF₂I (234 g, 18%), b.p. 89˜94° C. at 60 mm Hg (80×10² Pa) based on the recovery of starting material. ¹⁹F NMR (300 MHz, CD₃COCD₃: −65.33˜65.45 (2F, m), −82.72 (3F, t, J=7.2 Hz), −84.08˜84.21 (2F, m), −85.37˜85.47 (2F, m), −114.60˜114.75 (2F, m), −121.96˜122.18 (2F, m), −123.19 (2F, s), −126.43˜126.55 (2F, m), −131.09 (2F, s); MS: 613 (M⁺+1).

A mixture of fuming oleum (65% SO₃ in H₂SO₄, 75 g), C₃F₇OCF₂CF₂CF₂CF₂CF₂CF₂I (50 g) and P₂O₅ (0.236 g) was heated at 105° C. for 12 hours. The resulting C₃F₇OCF₂CF₂CF₂CF₂CF₂COF was separated and hydrolyzed with 22% sulfuric acid (160 mL) overnight. After phase separation, the final acid C₃F₇OCF₂CF₂CF₂CF₂CF₂COOH (36 g, 91%) was obtained by vacuum distillation. B.p. 114˜117° C. at 40 mm Hg (53.3×10² Pa); ¹⁹F NMR (300 MHz, CD₃COCD₃): −82.64 (3F, t, J=7.5 Hz), −84.07˜84.19 (2F, m), −85.29˜85.42 (2F, m), −120.15 (2F, t-t, J1=12.3 Hz, J2=3.4 Hz), −123.0˜123.1 (2F, m), −124.05˜124.19 (2F, m), −126.54-126.63 92F, m), −131.03 (2F, s). NH₄HCO₃ (2.71 g) in 22 mL of water was added drop wise to C₃F₇OCF₂CF₂CF₂CF₂CF₂COOH (16 g) in 173 mL of water. The reaction was stirred for two hours at room temperature and the resulting salt C₃F₇OCF₂CF₂CF₂CF₂CF₂COONH₄ (14 g, 85%) was obtained as a white solid after evaporating of the water. M.p. 131˜133° C.; ¹⁹F NMR (300 MHz, CD₃COCD₃): −84.64 (3F, t, J=7.5 Hz), −85.94˜86.17 (2F, m), −87.27˜87.45 (2F, m), −120.14 (2F, t-t, J=12.3 Hz), −125.09 (2F, s), −125.87125.95 (2F, s), −128.46 (2F, s), −133.03 (2F, s).

### EXAMPLES

### Example 1

1 L stainless reactor was charged with distilled water (450 mL), C₃F₇OCF₂CF₂CF₂COONH₄ (4.0 g) prepared as described above as Compound 1, disodium hydrogen phosphate (0.4 g) and ammonium persulfate (0.4 g), followed by introducing tetrafluoroethylene (TFE) (45 g) and perfluoro-(methyl vinyl ether) (PMVE) (40 g). The reactor heated at 70° C. for four hours under agitation. The polymer emulsion unloaded from the reactor was coagulated with saturated MgSO₄ aqueous solution. The polymer precipitate was collected by filtration and washed warm water (70° C.) several times. After drying in vacuum oven (100 mmHg) at 100° C. for 24 hours, 60 g of white polymer was obtained. Tg: −5.5° C.; Composition ¹⁹F NMR (mol %): PMVE/TFE (25.7/74.3). F content of the surfactant used in polymerization was about 0.5% by weight.

### Example 2

1 L stainless reactor was charged with distilled water (450 mL), C₃F₇OCF₂CF₂CF₂COONH₄ (3.0 g) prepared as described above as Compound 1, disodium hydrogen phosphate (0.4 g) and ammonium persulfate (0.4 g), followed by introducing tetrafluoroethylene (TFE) (40 g) and hexafluoropropylene (HFP) (200 g). The reactor heated at 70° C. for eight hours under agitation. The polymer emulsion unloaded from the reactor was coagulated with saturated MgSO₄ aqueous solution. The polymer precipitate was collected by filtration and washed with warm water (70° C.) several times. After drying in vacuum oven (100 mm Hg) (133.3×10² Pa) at 100° C. for 24 hours, 36 g of white polymer was obtained. Tm: −255° C.; Composition ¹⁹F NMR (mol %): HFP/TFE (12.4/87.6). F content of the surfactant used in polymerization was about 0.84% by weight.

### Example 3

The process of the invention is illustrated in the polymerization of copolymers of tetrafluoroethylene (TFE) with perfluoro(propyl vinyl ether) (PPVE) using the surfactant solution containing 4.2 gram of a 20% by weight aqueous solution of ammonium 2,2,3,3,4,4-hexafluoro-4-(perfluoropropoxy)butanoate, (CF₃CF₂CF₂OCF₂CF₂CF₂COONH₄) which was prepared as described above as Compound 1. Deaerated water was used in the polymerizations. It was prepared by pumping deionized water into a large stainless steel vessel and vigorously bubbling nitrogen gas for approximately 30 minutes through the water to remove all oxygen. The reactor was a 1 Liter vertical autoclave equipped with a three-bladed ribbon agitator and a baffle insert was used. No chain transfer agent was used. A vacuum of approximately −13 PSIG (11.7 kPa) was applied to the reactor. This was used to draw in a solution of 4.2 gram of a 20% by weight aqueous solution of ammonium 2,2,3,3,4,4-hexafluoro-4-(perfluoropropoxy)butanoate and 500 mL deaerated water as a precharge. The reactor was then purged three times (agitator=100 RPM) by pressurization with nitrogen gas to 50 PSIG (450 kPa) followed by venting to 1 PSIG (108 kPa) to reduce oxygen content. It was further purged three times (agitator=100 rpm) by pressurization with gaseous tetrafluoroethylene (TFE) to 25 PSIG (274 kPa) followed by venting to 1 PSIG (108 kPa) further insuring that the contents of the autoclave were free of oxygen. The agitator rate was increased to 600 RPM, the reactor was heated to 65° C., and then perfluoro(propyl vinyl ether) (PPVE) (12.8 g) was pumped as a liquid into the reactor.

When at temperature, the reactor pressure was raised to a nominal 250 PSIG (1.83 MPa) by adding tetrafluoroethylene (TFE) (˜38 g). An initiator solution (ammonium persulfate), was fed to the reactor at a rate of 20 mL/min for 1 min. to provide a precharge of 0.02 g ammonium persulfate. It was then pumped at a rate of 0.25 mL/min. until the end of the batch which was defined as the point at which 90 g of tetrafluoroethylene (TFE) had been consumed, measured as mass loss in a tetrafluoroethylene (TFE) weigh tank. At kickoff (defined as the point at which a 10 PSIG (70 kPa) pressure drop was observed) the polymerization was deemed to have been started, which was also the start point for feeding PPVE at a rate of 0.12 g/min. for the remainder of the polymerization. Reactor pressure was kept constant at 250 PSIG (1.83 MPa) by feeding tetrafluoroethylene (TFE) as needed throughout the entire polymerization. After 90 g of tetrafluoroethylene (TFE) had been consumed, the agitator was slowed to 200 RPM, all feeds to the reactor were shut off, and the contents were cooled to 30° C. over the course of 30 minutes. The agitator was then turned down to 100 RPM and the reactor was vented to atmospheric pressure.

The fluoropolymer dispersion thus produced had a solids content of typically around 15-16% by weight. Polymer was isolated from the dispersion by freezing, thawing and filtration. The polymer was washed with deionized water and filtered several times before being dried overnight in a vacuum oven at 80° C. and a vacuum of 30 mm Hg (4 kPa). The polymer was analyzed according to Test Methods 2, 3 and 4. Results are reported in Table 2.

### Comparative Example C

The general procedure of Example 3 was employed using a surfactant solution of 3.7 g of a 20% by weight of an aqueous solution of C₃F₇OCF₂CF₂COONH₄. Results are reported in Table 2.

TABLE 2
(TFE)/PPVE)* Polymerization

| | | | | | Time to | |
|---|---|---|---|---|---|---|
| | | | | | consume 90 g | |
| | | | Total | Time to | tetrafluoro- | Total |
| | Surfactant | Surfactant | Initiator | kickoff | ethylene (TFE) | batch |
| Example | mmol | micrograms/g | APS (g) | (min.) | (min.) | mass (g) |
| 3 | 2.1 | 1307.6 | 4.33E−02 | 11 | 82 | 642.4 |
| 3 | 2.1 | 1298.5 | 4.30E−02 | 10 | 82 | 646.9 |
| 3 | 2.1 | 1298.9 | 4.43E−02 | 11 | 86 | 646.7 |
| 3 | 2.1 | 1304.3 | 4.48E−02 | 10 | 89 | 644.0 |
| Comparative C | 2.1 | 1142.2 | 4.45E−02 | 9 | 89 | 647.9 |
| Comparative C | 2.1 | 1147.3 | 4.18E−02 | 6 | 81 | 645.0 |
| Comparative C | 2.1 | 1153.7 | 4.20E−02 | 5 | 83 | 641.4 |
| Comparative C | 2.1 | 1145.9 | 4.35E−02 | 5 | 89 | 645.8 |
| Comparative C | 2.1 | 1149.4 | 4.35E−02 | 6 | 88 | 643.8 |
| Comparative C | 2.1 | 1151.6 | 4.35E−02 | 4 | 90 | 642.6 |

| | Total | Ave. | | Undispersed | Coagulum as | |
|---|---|---|---|---|---|---|
| | polymer | particle | | polymer | wt. % of total | Wt. % |
| Example | mass (g) | size (nm) | % Solids | coagulum, g | polymer | PPVE |
| 3 | 103.8 | 145 | 15.8 | 2.2 | 2.2 | 5.5 |
| 3 | 105.8 | 143 | 16.1 | 1.7 | 1.6 | 3.8 |
| 3 | 104.8 | 138 | 16.1 | 0.8 | 0.8 | 5.7 |
| 3 | 96.4 | 147 | 14.7 | 1.9 | 2.0 | 5.5 |
| Comparative C | 106.8 | 174 | 15.8 | 4.7 | 4.6 | 3.9 |
| Comparative C | 106.2 | 175 | 15.9 | 3.7 | 3.6 | 4.1 |
| Comparative C | 106.4 | 181 | 15.9 | 4.6 | 4.5 | 3.9 |
| Comparative C | 106.9 | 186 | 15.8 | 5.1 | 5.0 | 4.1 |
| Comparative C | 107.5 | 180 | 15.8 | 5.8 | 5.7 | 3.8 |
| Comparative C | 101.8 | 178 | 15.5 | 2.0 | 2.0 | 4.1 |

*Tetrafluoroethylene/Perfluoro(propyl vinyl ether)

The data in Table 2 demonstrated that use of Compound 1 in Example 3 using the process of the invention provided a copolymer having a smaller particle size and less undispersed polymer than use of Comparative Compound B in Comparative Example C. The smaller particle size indicated greater copolymer dispersion stability for Compound 1 in Example 3 than for Compound B in Comparative Example C.

### Example 4

1 L stainless reactor was charged with distilled water (450 mL), C₃F₇O CF₂CF₂CF₂CF₂CF₂COONH₄ (4.0 g) prepared as described above as Compound 2, disodium hydrogen phosphate (0.4 g) and ammonium persulfate (0.4 g), followed by introducing tetrafluoroethylene (45 g) and perfluoro-(methyl vinyl ether) (40 g). The reactor heated at 70° C. for four hours under agitation. The polymer emulsion unloaded from the reactor was coagulated with saturated MgSO₄ aqueous solution. The polymer precipitate was collected by filtration and washed with warm water (70° C.) several times. After drying in vacuum oven at 100 mm Hg (133.34×10² Pa) at 100° C. for 24 hours, 60 g of white polymer was obtained. Tg: −5.5° C.; Composition ¹⁹F NMR (mol %): PMVE/tetrafluoroethylene (TFE) (24.9/74.3). F content of the surfactant used in polymerization was about 0.57% by weight.

### Example 5

1 L stainless reactor was charged with distilled water (450 mL), C₃F₇O CF₂CF₂CF₂CF₂CF₂COONH₄ (4.0 g) prepared as described above as Compound 2, disodium hydrogen phosphate (0.4 g) and ammonium persulfate (0.4 g), followed by introducing tetrafluoroethylene (45 g) and hexafluoropropylene (200 g) (40 g). The reactor heated at 70° C. for eight hours under agitation. The polymer emulsion unloaded from the reactor was coagulated with saturated MgSO₄ aqueous solution. The polymer precipitate was collected by filtration and washed with warm water (70° C.) several times. After drying in vacuum oven at 100 mm Hg (133.34×10² Pa) at 100° C. for 24 hours, 38 g of white polymer was obtained. Tm: 260° C.; Composition ¹⁹F NMR (mol %): HFP/tetrafluoroethylene (TFE) (14.8/85.2). F content of the surfactant used in polymerization was about 0.43% by weight.

### Example 6

The process of the invention is illustrated in the polymerization of copolymers of tetrafluoroethylene (TFE) with perfluoro(alkyl vinyl ether), i.e., perfluoro(propyl vinyl ether) (PPVE). Deaerated water was used in the polymerizations. It was prepared by pumping deionized water into a large plastic vessel and vigorously bubbling nitrogen gas through the water to remove all oxygen. The deaerated water was removed as needed from this plastic vessel for use in the polymerization. The reactor was a 1 gallon horizontal autoclave made of HASTELLOY, equipped with an extended anchor-type agitator, which had a central shaft in the middle that ran the length of the clave. The end furthest from the drive was closed and the outer blades swept the inside of the clave body within an inch or two (2.54 cm to 3.08 cm) of the interior wall. No chain transfer agent was used in these Examples. The reactor was charged by means of a syringe pump with 1850 g of deaerated water. Through an open port on the reactor, then, was pipetted into the reactor 48.6 g of a 20% by weight solution of Compound 1 as surfactant, prepared as described above. The surfactant was added directly to the reactor from the pipette to avoid any cross-contamination that might arise in piping surfactants into the reactor. The deaerated water and Compound 1 solution made up the reactor precharge. The vessel was agitated at 100 RPM for 3-5 minutes and then the agitator was stopped. The reactor was then purged three times (agitator off) by pressurization with nitrogen gas to 80 PSIG (650 kPa) followed by venting to 1 PSIG (108 kPa) to reduce oxygen content. It was further purged three times (agitator off) by pressurization with gaseous tetrafluoroethylene (TFE) to 25 PSIG (274 kPa) followed by venting to 1 PSIG (108 kPa) further insuring that the contents of the autoclave were free of oxygen. The agitator rate was then increased to 100 RPM, the reactor was heated to 75° C., and then perfluoro(propyl vinyl ether) (PPVE) (31.5 ml) was pumped as a liquid into the reactor for one minute at the constant rate of 31.5 ml/min. When the vessel temperature equilibrated at 75° C., the reactor pressure was raised to a nominal 250 PSIG (1.83 MPa) by adding tetrafluoroethylene (TFE) through a pressure regulator into the reactor. An initiator solution, (1 g of ammonium persulfate in 1 liter of demineralized and deoxygenated water), was fed to the reactor at a rate of 20 mL/min for 1 min. to provide a precharge of 0.02 g ammonium persulfate. It was then pumped to the reactor at a rate of 105.7 mL/min for 1 min. followed by a rate of 1.01 mL/min. until the end of the batch, which was defined as the point at which 333 g of tetrafluoroethylene (TFE) had been fed to the reactor through a mass flow controller. At kickoff (defined as the point at which a 10 PSIG (70 kPa) pressure drop was observed) the polymerization was deemed to have started, which was also the start point for feeding perfluoro (propyl vinyl ether) (PPVE) at a rate of 0.30 g/min. for the rest of the polymerization. Reactor pressure was kept constant at 250 PSIG (1.83 MPa) by feeding tetrafluoroethylene (TFE) as needed throughout the entire polymerization. After 333 g of tetrafluoroethylene (TFE) had been consumed, all feeds to the reactor were shut off, and the contents were cooled to 30° C. over the course of about 90 minutes. The reactor was then vented to atmospheric pressure. The fluoropolymer dispersion thus produced had a solids content of typically around 20% by weight. Polymer was isolated from the dispersion by freezing, thawing and filtration. The polymer was washed with deionized water and filtered several times before being dried overnight in a vacuum oven at 80° C. and a vacuum of 30 mm Hg (4 kPa). The polymer was analyzed according to Test Methods 2, 3 and 4. Results are reported in Table 3.

### Comparative Example D

Following the procedure of Example 6, 79.6 g of a 20% by weight solution of the ammonia salt of CF₃(CF₂)₆COOH, ammonium perfluorooctanoate, was used as the surfactant polymerization aid. The resulting polymer was analyzed according to Test Methods 2, 3 and 4. Results are reported in Table 3.

### Comparative Example E

A mixture of fuming oleum (67% SO₃ in H₂SO₄, 75 g), C₃F₇OCF₂CF₂I (50 G) and P₂O₅ (0.295 g) was heated at 105° C. for 12 hours. The resulting C₃F₇OCF₂COF was separated and hydrolyzed with 22% sulfuric acid (110 mL) overnight. After phase separation, the acid C₃F₇OCF₂COOH was obtained by vacuum distillation. NH₄HCO₃ (4.4. g) in 22 mL of water was added dropwise to 21 g of the acid in 173 mL of water. The reaction was stirred for 2 hours at room temperature to yield the salt C₃F₇OCF₂COONH₄ as a white solid after evaporating the water. Following the procedure of Example 6, 78.6 g of 20% by weight aqueous solution of C₃F₇OCF₂COONH₄ was used as the surfactant polymerization aid. The resulting polymer was analyzed according to Test methods 2, 3 and 4. Results are reported in Table 3.

TABLE 3
TFE/PPVE^{a} Polymerization

| | Amount | | | | | | | | | | | |
|---|---|---|---|---|---|---|---|---|---|---|---|---|
| | Surfactant, | | | | | | | | | | | |
| | g, of | | Amount | | Run | | Solids | Wet | Dry | Coag^{c} | DSC | PPVE |
| | 20% | Amount | surfactant | Kickoff | Time | RDPS^{b} | % by | Coag^{c} | Coag^{c} | % by | Temp. | % by |
| Example | solution | TFE, (g) | mmol | (min) | (min) | (nm) | weight | (g) | (g) | weight | (° C.) | weight |
| Comp. D | 79.6 | 335 | 17.5 | 8 | 83 | 93 | 21.78 | 340.7 | 88.7 | 15.2 | 326.2 | 12.5 |
| Ex. 6 | 48.6 | 335 | 11.6 | 5 | 85 | 165 | 22.17 | 109.2 | 25.2 | 4.2 | 325.1 | 10.1 |
| Comp. E | 78.6 | 323 | 17.5 | 4 | 91 | 221 | 15.21 | 428.5 | 401.8 | 54.8 | 325.7 | 6.5 |

^{a}= tetrafluoroethylene/perfluoro (propyl vinyl ether)
^{b}= raw dispersion particle size
^{c}= undispersed polymer coagulum

The data in Table 3 demonstrates that use of Example 6 in the process of the invention provided less undispersed polymer than Comparative Examples D and E. This indicated greater polymer stability with less tendency to precipitate out of solution, while having a particle of sufficient size to be commercially useful.

### Example 7

A perfluoroelastomer containing copolymerized monomers of tetrafluoroethylene (TFE), perfluoro(methyl vinyl)ether (PMVE), and perfluoro-8(cyano-5-methyl-3,6-dioxa-1-octene) (8CNVE) using the process of the present invention was prepared as follows: three aqueous streams were each fed continuously to a 1 liter mechanically stirred, water jacketed, stainless steel autoclave at a rate of 81 cc/hr. The first stream consisted of 1.13 g ammonium persulfate and 28.6 g of disodium hydrogen phosphate heptahydrate per liter of de-ionized water. The second stream consisted of 90 g of Compound 1 per liter of de-ionized water. The third stream consisted of 1.13 g of ammonium persulfate per liter of de-ionized water. Using a diaphragm compressor, a mixture of TFE (56.3 g/hr) and PMVE (68.6 g/hr) was fed at constant rate. The temperature was maintained at 85° C., the pressure at 4.1 MPa (600 psi), and the pH at 5.2 throughout the reaction. The polymer emulsion was removed continuously by means of a letdown valve and the unreacted monomers were vented. The polymer was isolated from the emulsion by first diluting it with deionized water at the rate of 8 liter deionized water per liter of emulsion, followed by addition of 320 cc of a magnesium sulfate solution (100 g magnesium sulfate heptahydrate per liter of deionized water) per liter of emulsion at a temperature of 60° C. The resulting slurry was filtered, the polymer solids obtained from a liter of emulsion were re-dispersed in 8 liters of deionized water at 60° C. After filtering, the wet crumb was dried in a forced air oven for 48 hr at 70° C. Polymer yield was 121 g per hour of reactor operation. The polymer composition, analyzed using FTIR, was 50.2 wt % PMVE, 2.35 wt % 8CNVE, the remainder being tetrafluoroethylene. The polymer had an inherent viscosity of 0.86 measured in a solution of 0.1 g polymer in 100 g of “Flutec” PP-11 (F2 Chemicals Ltd., Preston, UK). Mooney viscosity, ML (1+10), was 53.5, as determined according to ASTM D1646 with an L (large) type rotor at 175° C., using a preheating time of one minute and rotor operation time of 10 minutes.

What is claimed is:

1. A process comprising polymerizing at least one fluorinated monomer in an aqueous medium containing initiator and polymerization agent to form an aqueous dispersion of particles of fluoropolymer, wherein said polymerization agent is a compound of the formula (I):
R_{f}—O—(CF₂)ₙ—COOX (I)
wherein
R_{f} is CF₃CF₂CF₂—,
n is an integer equal to 3, 5 or 7, and
X is H, NH₄, Li, Na or K.

2. The process of claim 1 wherein n is 3.

3. The process of claim 1 wherein said polymerization agent is present in said aqueous medium in an amount of from about 0.01% to about 10% based on the weight of water in said aqueous medium.

4. The process of claim 1 wherein said polymerization agent is present in said aqueous medium in an amount of from about 0.05% to about 3% based on the weight of water in said aqueous medium.

5. The process of claim 1 wherein said aqueous dispersion of particles of fluoropolymer formed has a fluoropolymer solids content of at least about 10% by weight.

6. The process of claim 1 wherein said aqueous dispersion of particles of fluoropolymer formed has a fluoropolymer solids content of about 14% by weight to about 65% by weight.

7. The process of claim 1 wherein said aqueous medium is substantially free of perfluoropolyether oil.

8. The process of claim 1 wherein said polymerization medium is substantially free of fluoropolymer seed at polymerization kick-off.

9. The process of claim 1 wherein said polymerizing produces less than about 10% by weight undispersed fluoropolymer based on the total weight of fluoropolymer produced.

10. The process of claim 1 wherein said polymerizing produces less than about 3% by weight undispersed fluoropolymer based on the total weight of fluoropolymer produced.

11. The process of claim 1 which is conducted as a batch process, semi-batch process, or as a continuous process.

12. The process of claim 1 wherein said fluoropolymer is a perfluoroelastomer.
